(19) United States
(12) Patent Application Publication
(10) Pub. No.: US 2019/0166792 A1
(43) Pub. Date: Jun. 6, 2019

(54) Modular Animal Track System

(71) Applicant: John MacVicar, Mission City (CA)

(72) Inventor: John MacVicar, Mission City (CA)

(21) Appl. No.: 15/832,075

(22) Filed: Dec. 5, 2017

(51) Int. Cl. A01K 1/03; A01K 11/00

(52) U.S. Cl. CPC A01K 1/03; A01K 29/005; A01K 11/006

(57) ABSTRACT

A modular animal track system for keeping an animal in a selected area includes a track that is coupled to a support surface. The track has a first end, a second end, a top side, and a bottom side. The top side has a top notch therein that extends toward the bottom side and through each of the first and second ends. The bottom side has a bottom notch therein that extends toward the top side and through each of the first and second ends. A guide is slidably attached to the track wherein the guide can move between the first and second ends. A first cap is positioned on the first end and a second cap is positioned on the second end to inhibit the guide from exiting the track. A leash is attached to the guide. A collar is positioned on an animal and attached to the leash.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art including information disclosed under 37 CFR 1.97 and 1.98.

The disclosure and prior art relates to animal guiding systems and more particularly pertains to a new animal guiding system for keeping an animal in a selected area.

### BRIEF SUMMARY OF THE INVENTION

An embodiment of the disclosure meets the needs presented above by generally comprising a track that is configured to be coupled to a vertical support surface. The track has a first end, a second end, a top side, and a bottom side. The top side has a top notch therein that extends toward the bottom side. The top notch is elongated and extends through each of the first end and the second end. The bottom side has a bottom notch therein that extends toward the top side. The bottom notch is elongated and extends through each of the first end and the second end. A guide is slidably attached to the track such that the guide can move from the first end to the second end along the track. A first cap is removably positioned on the first end and inhibits the guide from exiting the track through the first end. A second cap is removably positioned on the second end and inhibits the guide from exiting the track through the second end. A leash is attached to the guide. A collar is included and configured to be positioned on an animal and is attached to the distal end of the leash.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front side view of a modular animal track system according to an embodiment of the disclosure.

FIG. 2 is a side view of an embodiment of the disclosure.

FIG. 3 is a front view of an embodiment of the disclosure.

FIG. 4 is a front side view of an embodiment of the disclosure.

FIG. 5 is a top side view of an embodiment of the disclosure.

FIG. 6 is a top side view of an embodiment of the disclosure.

### DETAILED DESCRIPTION OF THE INVENTION

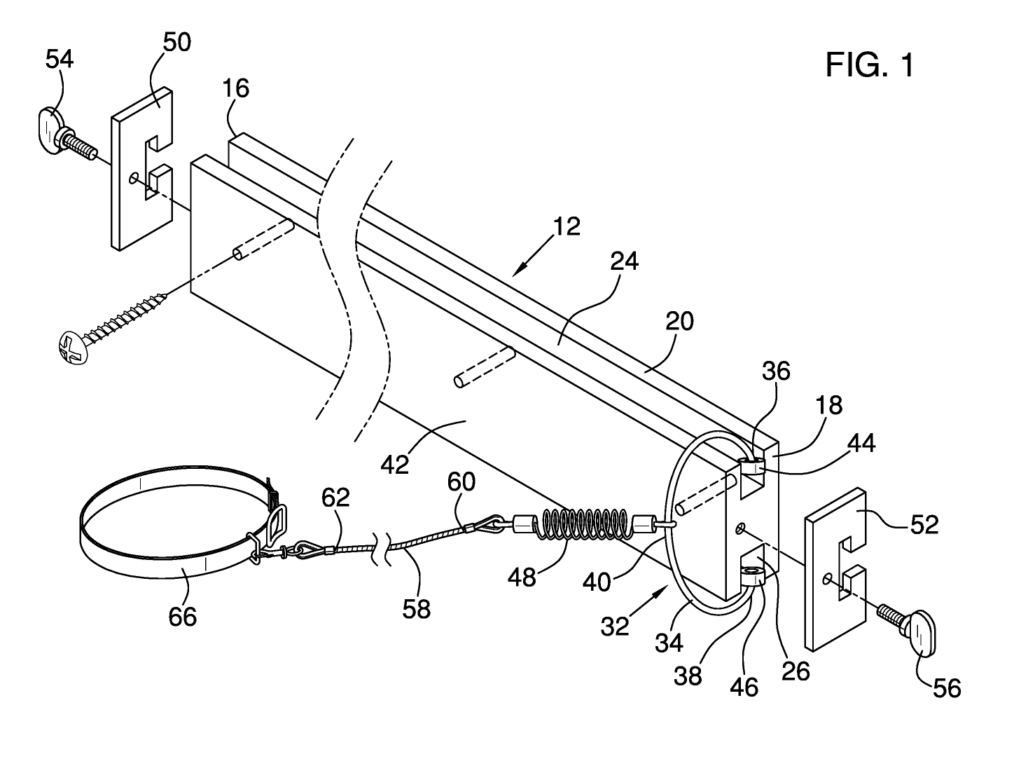

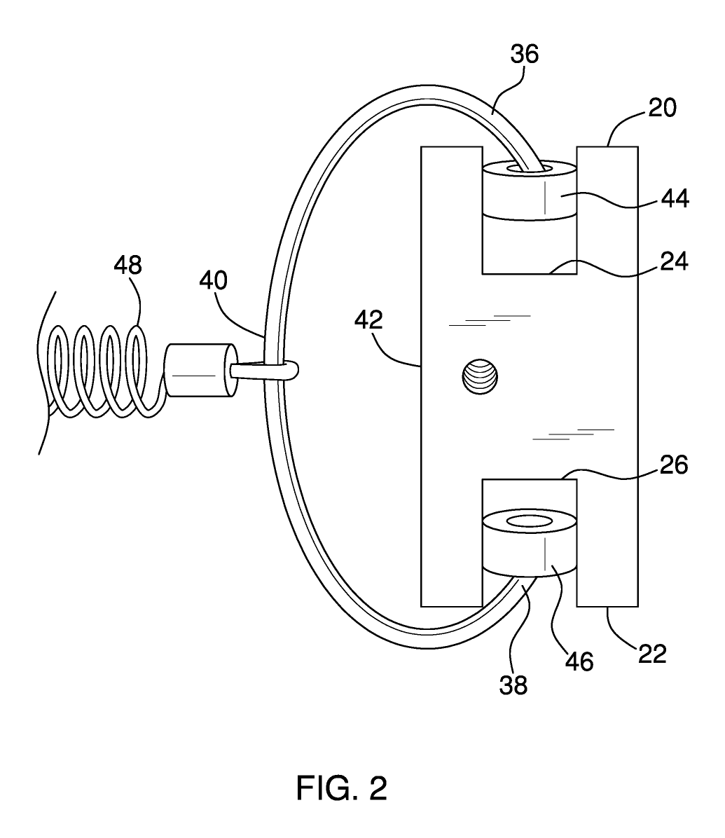

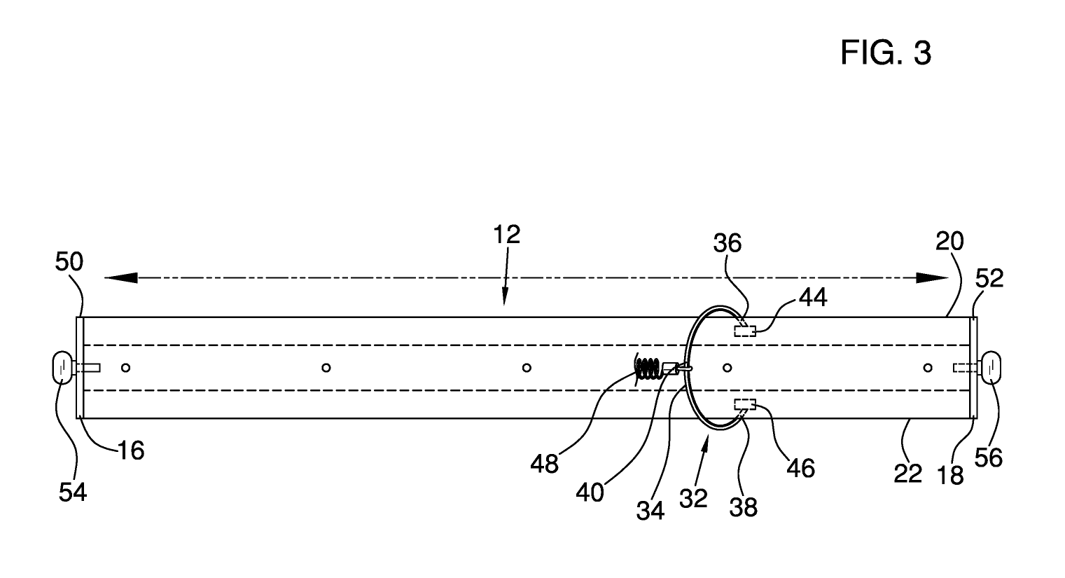

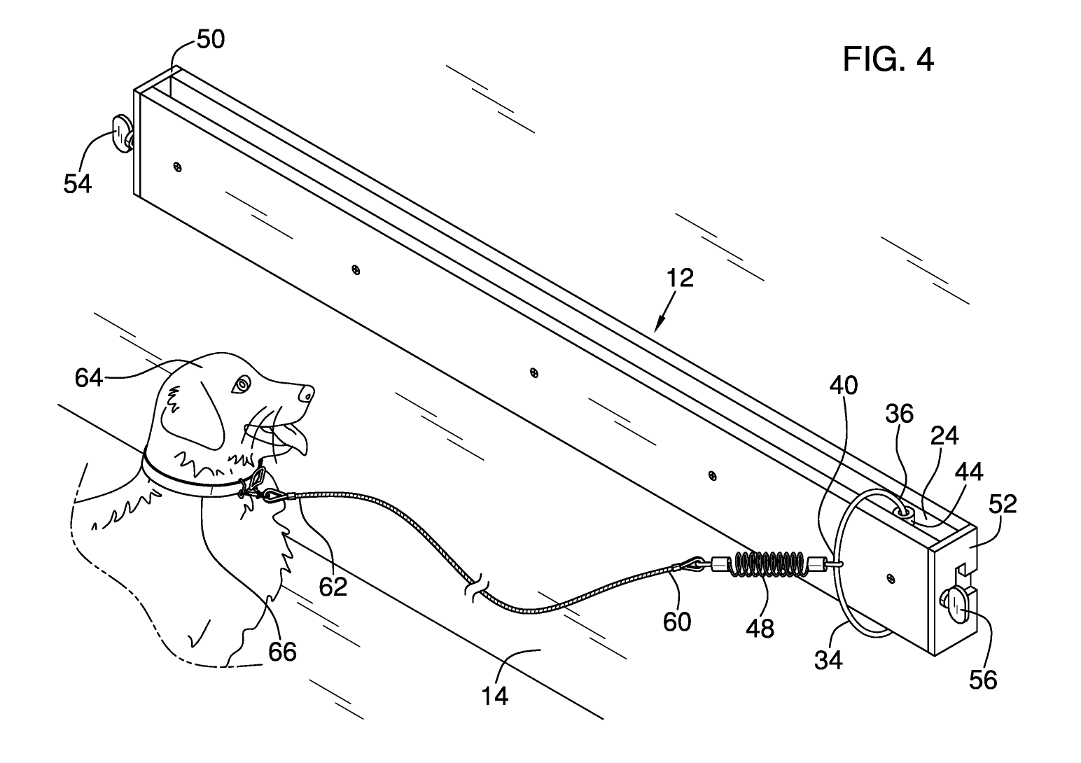

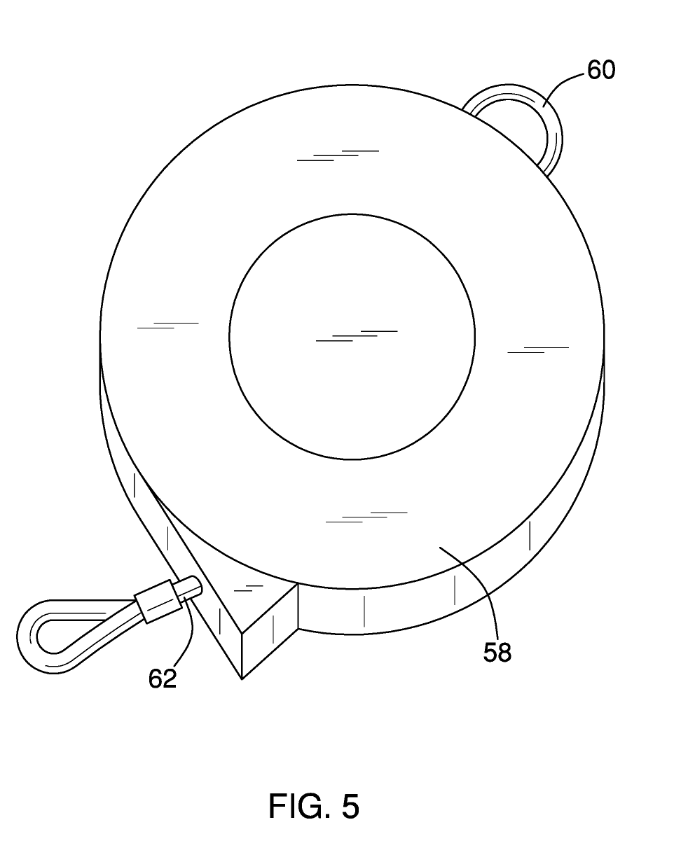

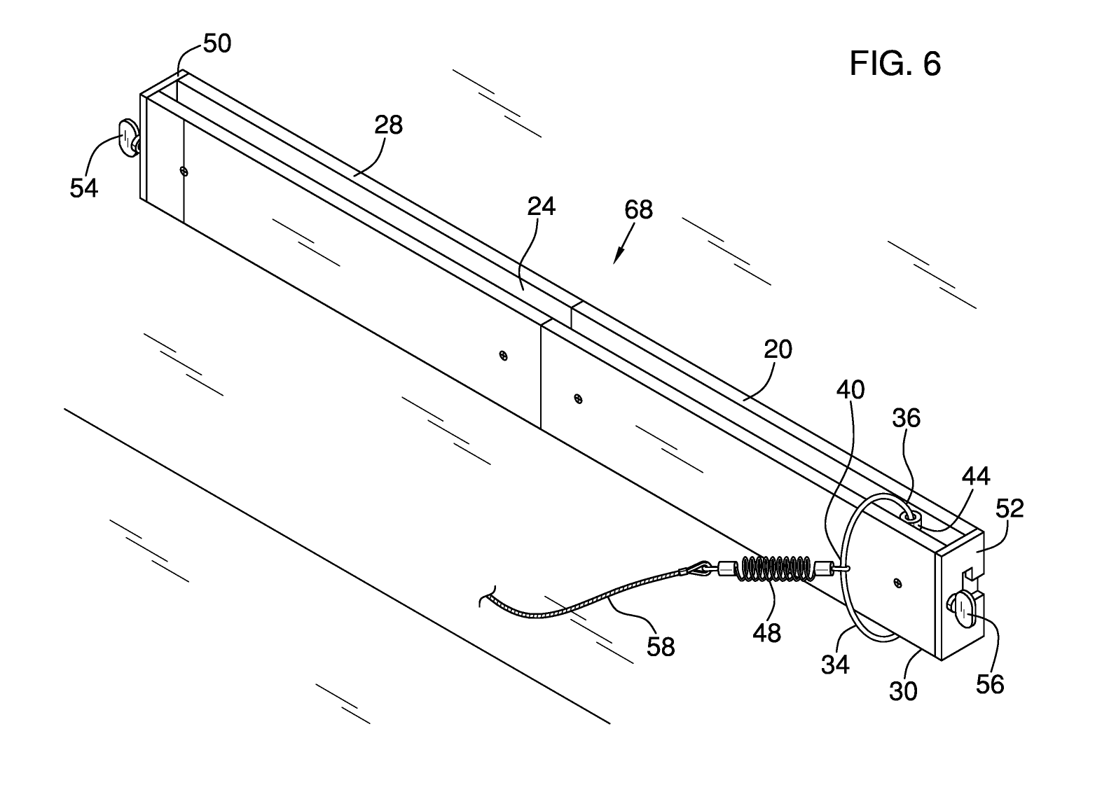

With reference now to the drawings, and in particular to FIGS. 1 through 6 thereof, a new animal guiding system embodying the principles and concepts of an embodiment of the disclosure and generally designated by the reference numeral 10 will be described.

As best illustrated in FIGS. 1 through 6, the modular animal track system 10 generally comprises a track 12 that is coupled to a vertical support surface 14. The track 12 has a first end 16, a second end 18, a top side 20, and a bottom side 22. The top side 20 has a top notch 24 therein that extends toward the bottom side 22. The top notch 24 is elongated and extends through each of the first end 16 and the second end 18. The bottom side 22 has a bottom notch 26 therein that extends toward the top side 20. The bottom notch 26 is elongated and extends through each of the first end 16 and the second end 18. The track 12 may be used with other tracks. For example, a first track 28 may abut a second track 30 such that top notch 24 of the first track 28 is coextensive with the top notch 24 of the second track 30 and the bottom notch 26 of the first track 28 is coextensive with the bottom notch 26 of the second track 30. Each of the tracks 12 may be angled to be positioned around buildings and other structures.

A guide 32 is slidably attached to the track 12 such that the guide 32 can move from the first end 16 to the second end 18 along the track 12. The guide 32 includes a mount 23 that has an upper end 36 and a lower end 38. The upper end 36 is positioned in the top notch 24 and the lower end 38 is positioned in the bottom notch 26. The mount 34 comprises a rigid material and has medial portion 40 positioned forward of a front side 42 of the track.

A top slide 44 is attached to the upper end 36 and is rotatable with respect to the mount 34. The top slide 44 has a rotational axis that is vertically orientated and extends through the top and bottom sides 20, 22 of the track 12. A bottom slide 46 is attached to the lower end 38 and is rotatable with respect to the mount 34. The bottom slide 46 has a rotational axis that is vertically orientated and extends through the top and bottom sides 20, 22 of the track 12. A spring 48 is attached to the mount 34 and positioned on the medial portion 40 of the mount 34.

Alternatively a second guide 50 may be included that mirrors the first guide 32. This embodiment may be used to better retain a large animal to the track 12. A support rod 52 is attached to and extends between the first guide 32 and the second guide 50. The support rod 52 comprises a first coupler 54 and a second coupler 58 that is attached to and extends perpendicularly between the first guide 32 and the second guide 50. The first coupler 54 and the second coupler 58 are spaced from each other. A third coupler 58 is attached to and extends perpendicularly between the first coupler 54 and the second coupler 58. In this embodiment the spring 48 is attached to the third coupler 58.

A first cap 60 is removably positioned on the first end 16 and inhibits the guide from exiting the track 12 through the first end 16. A second cap 62 is removably positioned on the second end 18 and inhibits the guide from exiting the track 12 through the second end 18. A first fastener 64 is removably positioned through the first cap 60 and into the first end 16 such that the first cap 60 is removably fastened to the first end 16. A second fastener 66 is removably positioned through the second cap 62 and into the second end 18 such that the second cap 62 is removably fastened to the second end 18. The first and second fasteners may comprise a screw, a bolt or any other fastener suitable to secure a corresponding one of the caps to a corresponding one of the ends.

A leash 68 is attached to the guide 32. The leash 68 has a proximal end 70 and a distal end 72 with respect to the guide 32. The proximal end 70 is coupled to the spring 48 such that the spring absorbs tension when the leash 68 is fully extended wherein the spring 48 inhibits an animal 74 from sustaining an injury from the leash 68. A collar 76 is positioned on the animal 74 and is attached to the distal end 72 of the leash 68. The leash 68 may be a conventional leash, an extendable leash, or any material that can act as a tether to link the collar 76 to the spring 48 and restrain the animal 74.

In use, the assembly 10 is used to limit the movement of an animal 74. The track 12 is positioned on the vertical support surface 14. The guide 32 is placed on the track 12 and then the first cap 60 is attached to the first end 16 and the second cap 62 is attached to the second end 18. The collar 76 is positioned on the animal 74 and the distal end 72 of the leash 68 is attached to the collar 76. The proximal end 70 of the leash 68 is connected to the spring 48. The animal 74 is then limited distance from the guide 32 to the collar 76 with the guide 32 moveable laterally along the track 12 from the first end 16 to the second end 18. If more than one track 12 is used and placed adjacent to other ones of the tracks 12 the first cap 60 and second cap 62 are placed on opposite ends of the combined track system such that there is only one first cap 60 and one second cap 62 and the combined track system is in between the first cap 60 and the second cap 62.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A modular animal run system comprising:
a track being configured to be coupled to a vertical support surface, said track having a first end, a second end, a top side, and a bottom side, said top side having a top notch therein extending toward said bottom side, said top notch being elongated and extending through each of said first end and said second end, said bottom side having a bottom notch therein extending toward said top side, said bottom notch being elongated and extending through each of said first end and said second end;
a guide being slidably attached to said track such that said guide can move from said first end to said second end along said track;
a first cap being removably positioned on said first end, said first cap inhibiting said guide from exiting said track through said first end;
a second cap being removably positioned on said second end, said second cap inhibiting said guide from exiting said track through said second end;
a leash being attached to said guide; and
a collar configured for being positioned on an animal, said collar being attached to said distal end of said leash.

2. The modular animal run system according to claim 1, wherein said guide includes:
a mount having a upper end and a lower end, said upper end being positioned in said top notch and said lower end being positioned in said bottom notch, said mount having medial portion positioned forward of a front side of said track;
a spring being attached to said mount, said spring being positioned on said medial portion of said mount; and
said leash being attached to said spring.

3. The modular animal run system according to claim 2, wherein said guide further includes:
a top slide being attached to said upper end; and
a bottom slide being attached to said lower end.

4. The modular animal run system according to claim 3, wherein said top slide is rotatable with respect to said mount, said top slide having a rotational axis being vertically orientated and extending through said top and bottom sides of said track, said bottom slide being rotatable with respect to said mount, said bottom slide having a rotational axis being vertically orientated and extending through said top and bottom sides of said track.

5. The modular animal run system according to claim 1, further including:
a first fastener being removably positioned through said first cap and into said first end such that said first cap is removably fastened to said first end; and
a second fastener being removably positioned through said second cap and into said second end such that said second cap is removably fastened to said second end.

6. A modular animal run system comprising:
a track being configured to be coupled to a vertical support surface, said track having a first end, a second end, a top side, and a bottom side, said top side having a top notch therein extending toward said bottom side, said top notch being elongated and extending through each of said first end and said second end, said bottom side having a bottom notch therein extending toward said top side, said bottom notch being elongated and extending through each of said first end and said second end;
a guide being slidably attached to said track such that said guide can move from said first end to said second end along said track, said guide including:
a mount having a upper end and a lower end, said upper end being positioned in said top notch and said lower end being positioned in said bottom notch, said mount comprising a rigid material and having a medial portion positioned forward of a front side of said track;
a top slide being attached to said upper end, said top slide being rotatable with respect to said mount, said top slide having a rotational axis being vertically orientated and extending through said top and bottom sides of said track;
a bottom slide being attached to said lower end, said bottom slide being rotatable with respect to said mount, said bottom slide having a rotational axis being vertically orientated and extending through said top and bottom sides of said track;
a spring being attached to said mount, said spring being positioned on said medial portion of said mount;
a first cap being removably positioned on said first end, said first cap inhibiting said guide from exiting said track through said first end;
a second cap being removably positioned on said second end, said second cap inhibiting said guide from exiting said track through said second end;
a first fastener being removably positioned through said first cap and into said first end such that said first cap is removably fastened to said first end;
a second fastener being removably positioned through said second cap and into said second end such that said second cap is removably fastened to said second end;
a leash being attached to said guide, said leash having a proximal end and a distal end with respect to said guide, said proximal end being coupled to said spring, said spring absorbing tension when said leash is fully extended wherein said spring is configured to inhibit an animal from sustaining an injury from said leash; and
a collar configured for being positioned on the animal, said collar being attached to said distal end of said leash.

7. A modular animal run system comprising:
a track being configured to be coupled to a vertical support surface, said track having a first end, a second end, a top side, and a bottom side, said top side having a top notch therein extending toward said bottom side, said top notch being elongated and extending through each of said first end and said second end, said bottom side having a bottom notch therein extending toward said top side, said bottom notch being elongated and extending through each of said first end and said second end;
a pair of guides including a first guide and a second guide, both of said first guide and said second guide being slidably attached to said track such that both of said first guide and said second guide can move from said first end to said second end along said track, both of said first guide and said guide including:
a mount having a upper end and a lower end, said upper end being positioned in said top notch and said lower end being positioned in said bottom notch, said mount comprising a rigid material and having a medial portion positioned forward of a front side of said track;
a top slide being attached to said upper end, said top slide being rotatable with respect to said mount, said top slide having a rotational axis being vertically orientated and extending through said top and bottom sides of said track;
a bottom slide being attached to said lower end, said bottom slide being rotatable with respect to said mount, said bottom slide having a rotational axis being vertically orientated and extending through said top and bottom sides of said track;
a support rod being attached to and extending between said first guide and said second guide, said support rod comprising:
a first coupler and a second coupler being attached to and extending perpendicularly between said first guide and said second guide, both of said first coupler and said second coupler being spaced from each other;
a third coupler being attached to and extending perpendicularly between said first coupler and said second coupler;
a spring being attached to said third coupler;
a first cap being removably positioned on said first end, said first cap inhibiting said guide from exiting said track through said first end;
a second cap being removably positioned on said second end, said second cap inhibiting said guide from exiting said track through said second end;
a first fastener being removably positioned through said first cap and into said first end such that said first cap is removably fastened to said first end;
a second fastener being removably positioned through said second cap and into said second end such that said second cap is removably fastened to said second end;
a leash being attached to said support rod, said leash having a proximal end and a distal end with respect to said support rod, said proximal end being coupled to said spring, said spring absorbing tension when said leash is fully extended wherein said spring is configured to inhibit an animal from sustaining an injury from said leash; and
a collar configured for being positioned on the animal, said collar being attached to said distal end of said leash.
